(19) United States
(12) Patent Application Publication
(10) Pub. No.: US 2016/0273480 A1
(43) Pub. Date: Sep. 22, 2016

(54) ENGINE CYLINDER AND LINER ASSEMBLY

(71) Applicant: CUMMINS IP, INC., Minneapolis, MN (US)

(72) Inventors: John Purcell, Louisa, VA (US); Aaron Quinton, Columbus, IN (US); Nathaniel P. Hassall, Thirsk (GB); John C. Wall, Columbus, IN (US)

(73) Assignee: Cummins IP, Inc., Minneapolis, MN (US)

(21) Appl. No.: 14/442,257

(22) PCT Filed: Nov. 25, 2013
(86) PCT No.: PCT/US13/71605

§ 371 Date: May 12, 2015

Related U.S. Application Data
(60) Provisional application No. 61/732,094, filed on Nov. 30, 2012.

(51) Int. Cl. F02F 1/16; F02F 3/00

(52) U.S. Cl. CPC F02F 1/163; F02F 3/0015

(57) ABSTRACT

Disclosed herein is an internal combustion engine includes a cylinder with a mid-stop shelf and a liner positioned within the cylinder. The liner includes a seat supported on the mid-stop shelf. Further, the liner defines a piston channel. The engine also includes a coolant conduit between the cylinder and the liner. The coolant conduit located above the mid-stop shelf and seat. Additionally, the engine includes a piston with a head portion and a skirt portion. The piston is movable within the piston channel between an upper-most position and a lowermost position. In the upper-most position, the skirt portion of the piston is positioned below the mid-stop shelf and seat.

### CROSS-REFERENCE TO RELATED APPLICATION

This application claims the benefit of U.S. Provisional Patent Application No. 61/732,094, filed Nov. 30, 2012, which is incorporated herein by reference

### FIELD

This disclosure relates generally to internal combustion engines, and more particularly to the cylinders and associated liners of internal combustion engines.

### BACKGROUND

The incorporation of replaceable cylinder liners in the design of an internal combustion engine provides numerous advantages to the manufacturer and user of such an engine in addition to the obvious benefit of allowing such liners to be replaced during overhaul of the engine. For example, cylinder liners eliminate the necessity to scrap an entire engine block during manufacture should the inside surface of one cylinder be improperly machined. Despite this and other advantages, numerous problems attend the use of replaceable cylinder liners as is exemplified by the great variety of liner designs previously used by engine manufacturers. While each of the previously known liner designs has various demonstrable advantages, no single design appears to be optimal.

Some conventional liner and cylinder configurations employ a mid-stop on which rests a seat formed in the liner. Although such mid-stops assist in maintaining the liners in place during use, significant cylinder distortion can be experienced at the mid-stop and liner seat interface during operation of the engine. The distortion of the cylinder may impact a skirt region of the piston causing wear and deformation of the piston.

So-called wet liner cylinder configurations incorporate coolant between the liner and cylinder block. Although coolant assists in reducing the working temperature of the liner and power cylinder, the coolant can cavitate and erode the liner due to a piston thrust forcing function.

### SUMMARY

The subject matter of the present application has been developed in response to the present state of the art, and in particular, in response to the problems and needs of engine cylinders and liners that have not yet been fully solved by currently available engine configurations. Accordingly, the subject matter of the present application has been developed to provide an engine cylinder and liner assembly that overcomes many of the shortcomings of the prior art.

According to one embodiment, an internal combustion engine includes a cylinder with a mid-stop shelf and a liner positioned within the cylinder. The liner includes a seat supported on the mid-stop shelf. Further, the liner defines a piston channel. The engine also includes a coolant conduit between the cylinder and the liner. The coolant conduit located above the mid-stop shelf and seat. Additionally, the engine includes a piston with a head portion and a skirt portion. The piston is movable within the piston channel between an uppermost position and a lowermost position. In the uppermost position, the skirt portion of the piston is positioned below the mid-stop shelf and seat.

In some implementations of the engine, the piston imparts a peak side thrust on the liner within a peak thrust zone. The peak thrust zone is located below the mid-stop shelf and the seat. According to certain implementations, an entirety of the coolant conduit is positioned above the mid-stop shelf and seat.

In certain implementations of the engine, the coolant conduit can include an annular space that extends circumferentially about the cylinder. The coolant conduit may be defined at least partially by a channel formed in the liner. The engine may further include an engine block that defines the cylinder. The coolant conduit can be defined at least partially by a channel formed in the engine block. In some implementations, the coolant conduit is defined between the channel formed in the engine block and the channel formed in the liner.

According to some implementations of the engine, an entirety of the coolant conduit is positioned a distance away from a top of the cylinder, where the distance is less than about 60% of an overall length of the piston. This distance can be less than about 40% of the overall length of the piston. In some implementations of the engine, an entirety of the coolant conduit is positioned a distance away from a top of the cylinder, where the distance is less than a height of a head portion of the piston.

In certain implementations of the engine, a circumference of the head portion has a diameter that is less than a diameter of a circumference of the skirt portion. The height of the skirt portion can be between about 40% and about 60% of an overall height of the piston.

According to another embodiment, a combustion cylinder assembly for an internal combustion engine with a piston that oscillates within the combustion cylinder assembly and imparts a peak side thrust within a peak thrust zone is disclosed. The assembly includes a cylinder with a mid-stop and a liner positioned within the cylinder. The liner includes a seat that is supported on the mid-stop. The assembly also includes a coolant conduit between the cylinder and the liner. The coolant conduit is located above mid-stop and seat. The peak thrust zone is located below the mid-stop and seat.

In some implementations of the assembly, the piston includes a head portion and a skirt portion. The piston oscillates within the combustion cylinder assembly between uppermost and lowermost positions. The assembly is configured such that when the piston is in the uppermost position, the skirt portion is positioned below the mid-stop and seat.

According to certain implementations of the assembly, the coolant conduit is defined at least partially by a channel formed in the liner. The channel formed in the liner aligns with a channel formed in an engine block of the internal combustion engine when the seat of the liner is supported on the mid-stop of the cylinder.

In yet certain implementations of the assembly, an entirety of the coolant conduit is positioned a distance away from a top of the cylinder. This distance can be less than about 40% of an overall length of the piston.

In some implementations of the assembly, an entirety of the coolant conduit is positioned a distance away from a top of the cylinder. This distance can be less than a height of a head portion of the piston.

According to yet some implementations of the assembly, an entirety of the coolant conduit is positioned a distance away from a top of the cylinder. This distance can be less than about 60% of an overall length of the piston.

In another embodiment, an internal combustion engine includes a cylinder with a mid-stop shelf. The mid-stop shelf is positioned a distance away from a top of the cylinder. The engine further includes a liner positioned within the cylinder. The liner includes a seat that is supported on the mid-stop shelf. The liner defines a piston channel. Additionally, the engine includes a coolant conduit between the cylinder and the liner. The coolant conduit is located between the top of the cylinder and the mid-stop and seat. The engine also includes a piston movable within the piston channel. The piston has an overall length. The distance is less than about 60% of the overall length of the piston.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings.

FIG. 1 is a cross-sectional side view of a cylinder and liner assembly of an internal combustion engine according to one embodiment;

FIG. 2 is a cross-sectional side view of a cylinder and liner assembly of an internal combustion engine according to yet another embodiment; and

FIG. 3 is a cross-sectional perspective view of a cylinder and liner assembly of an internal combustion engine according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Generally, according to some embodiments, described herein is an engine cylinder and liner assembly that utilizes a shorter coolant jacket to position a mid-stop formed in the engine block higher than conventional cylinder configurations. The higher positioning of the mid-stop locates the interface of the mid-stop and liner seat above the skirt profile region of the piston. Accordingly, the skirt profile region of the piston is not impacted by the cylinder distortion experienced at the mid-stop and liner seat interface during operation of the engine. Moreover, an entirety of the coolant jacket (e.g., the lowermost point of the coolant jacket) and mid-stop and liner seat interface are positioned above a peak piston thrust zone, which reduces the cavitation forcing anomaly associated with the implementation of a conventional coolant jackets. Moreover, by shortening the coolant jacket and positioning the mid-stop and liner seat interface higher, improvements in piston durability, noise/vibration/harshness (NVH), oil consumption, piston slap, and fretting may be experienced.

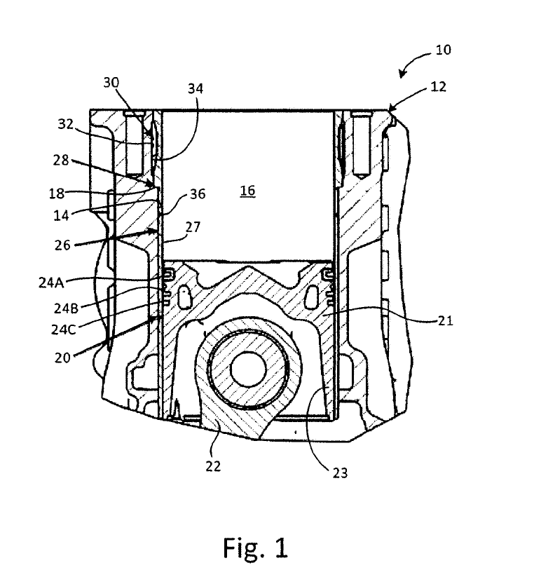

Referring to FIG. 1, a cross-sectional side view of one embodiment of an engine 10 is shown. The engine 10 includes an engine block 12 with a cylinder 14. The cylinder 14 includes an interior wall that defines a cylinder or combustion cavity 16. A mid-stop or shelf 18 is formed in the interior wall. The mid-stop 18 extends circumferentially about the cylinder and separates the cylinder cavity 16 into an upper section above the mid-stop and a lower section below the mid-stop. The upper section has a diameter greater than the lower section. The mid-stop 18 extends into the combustion cavity and includes a support surface configured to support a mating surface of a seat 28 formed in a cylinder liner 26. As defined herein, “below” means vertically below during normal upright operation of the engine relative to a horizontal surface.

The cylinder liner 26 is sized and shaped to nestably mate with the cylinder 14. Accordingly, the cylinder liner 26 includes a generally cylindrical-shaped tube with an exterior surface substantially matching the interior wall surface of the cylinder 14. The cylinder liner 26 includes an opposing interior surface 27 that defines the channel in the cylinder cavity along which a piston 20 travels during operation of the engine 10. The channel is coextensive with the cylinder cavity 16. The channel defined by the opposing interior surface 27 is cylindrical and sized to substantially match (e.g., be slightly less than an interference fit with) the exterior surface of the piston 20. Movement of the piston 20 within the liner channel is driven by a combustion event within the combustion cavity 16 above the piston. The seat 28 of the liner 26 extends circumferentially about the liner. The seat 28 rests on and is supported by the mid-stop 18. Accordingly, the mid-stop 18 and seat 28 each includes mating surfaces. Although not shown, a head gasket and cylinder head is mounted atop the cylinder and pressure fit against the cylinder, which results in a pressure being applied to the mid-stop 18 by the seat 28.

The piston 20 includes a head portion 21 and a skirt portion 23. As shown, the head portion 21 occupies a height H₂ of the total height of the piston 20, and the skirt portion 23 occupies the remaining height H₃ of the piston. In some implementations, the circumference or diameter of the head portion 21 is slightly less than the circumference or diameter of the skirt portion 23. Accordingly, the head portion 21 tends to contact and wear against the liner 26 less than the skirt portion 23. In this manner, the skirt portion 23 acts to guide, direct and/or stabilize the piston 20 through the combustion cavity 16 more than the head portion 21. The skirt portion 23 and liner 26 are separated by a boundary film lubrication layer, which is highly sensitive to micro-distortion of the liner surface 27. Accordingly, micro-distortion of the liner surface 27 can lead to penetration of the boundary film lubrication layer, which can cause an increase in the wear of the skirt portion 23 and liner 26. For this reason, the skirt portion 23 is more prone to wear by virtue of more frequent and intense loading of the boundary film lubrication layer, which can lead to contact with the wall of the liner as the piston 20 oscillates within the combustion cavity 16. Therefore, according to one definition, the skirt portion 23 of the piston 20 is the portion of the piston actively loading the interior surface 27 of the liner 26 through the boundary film lubrication layer. The total height of the piston 20 can be equal to the height H₂ of the head portion 21 plus the height H₃ of the skirt portion 23. In some implementations, the ratio of the height H₃ of the skirt portion 23 and the overall height of the piston 20 is less than between about 0.4 and about 0.6. In one implementation, the ratio of the height H₃ of the skirt portion 23 and the overall height of the piston 20 is about 0.5.

Generally, as opposed to guiding the piston 20 through the combustion cavity 16, the head portion 21 is configured to scrape oil from the liner 26 and promote a seal between the piston and liner. To this end, the head portion 21 includes a scraper ring 24A and a series of sealing members or rings 24B-C positioned about the circumference of the head portion of the piston. The rings 24A-C are positioned within circumferential grooves formed in the head portion 21. The scraper ring 24A can be U-shaped and configured to scrape oil from the interior surface 27 of the liner 26. The sealing rings 24B-C create a seal between the piston head and the interior surface 27 of the liner 26 to prevent pre-combustion and post-combustion constituents from passing between the piston head and liner. The piston 20 rotatably drives a crankshaft via a connecting rod 22 that couples the piston to the crankshaft.

The cylinder liner 26 can be configured to be in direct surface-to-surface contact with the interior surface of the cylinder 14 along most of the length of the cylinder liner. However, the cylinder block 12 includes a coolant conduit 30 that extends circumferentially about a portion of the liner 26 between the liner and the cylinder 14. The coolant conduit 30 contains a coolant, such as water, that is recirculated through the coolant conduit via a pump or other driven device. Heat from the combustion process is transferred through the liner 26 and into the coolant contained in the coolant conduit 30. In some implementations, a portion of the heat is transferred through the piston 20 before being transferred to the liner 26 and into the coolant conduit 30. As the coolant in the coolant conduit 30 is recirculated, the transferred heat is removed from the cylinder area. In this manner, the coolant conduit 30 is configured to promote heat transfer from the cylinder 14 and reduce the temperature of the working components associated with the cylinder, such as the cylinder block 12, piston 20, and liner 26. To prevent the leakage of coolant from the coolant conduit 30 along the length of the cylinder 14 between the liner 26 and the cylinder block, a sealing member 36 may be placed between the liner and cylinder block.

Essentially, the coolant conduit 30 is pocket or jacket formed between the liner 26 and cylinder 14. In the illustrated embodiment, the coolant conduit 30 is defined between a channel 32 formed in the interior wall of the cylinder 14 and a channel 34 formed in an exterior surface of the liner 26. Accordingly, the channel 32 and channel 34 are alignable to cooperatively form therebetween the coolant conduit 30.

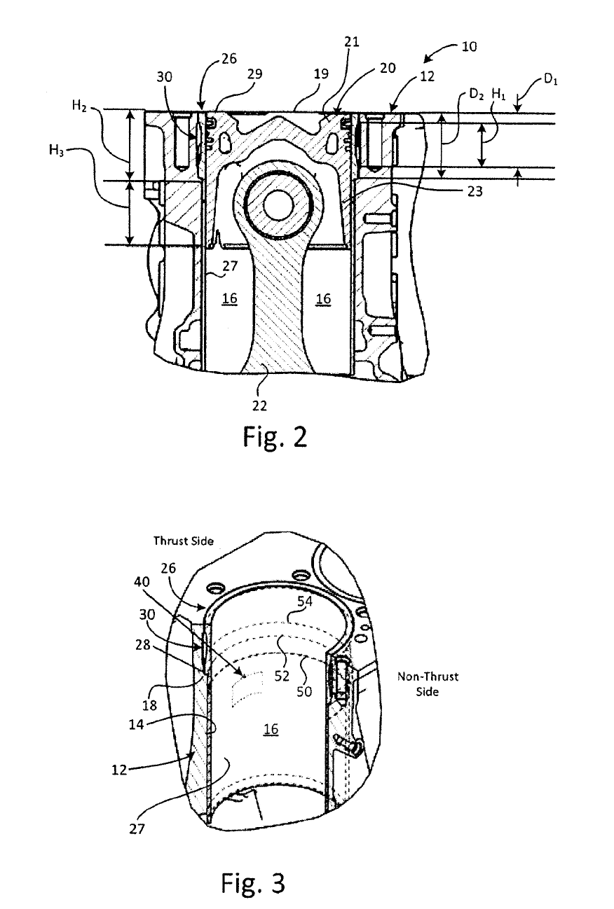

Referring to FIG. 2, the coolant conduit 30 has a height (or length) H₁ extending from an upper end to a lower end of the coolant conduit. The height H₁ of the coolant conduit 30 is relatively small compared to conventional coolant conduits. Accordingly, because of the smaller height H₁ of the coolant conduit 30, the lowermost extent of the coolant conduit 30 can be located higher on the combustion cylinder 14 (i.e., closer to a top 19 of the combustion cavity 16) compared to conventional configurations. In the illustrated embodiment, the lowermost extent of the coolant conduit 30 is located a distance D₁ away from the top 19 of the combustion cavity 16, which is corresponds with the topmost position of an upper surface 29 of the piston 20 (e.g., when the piston 20 is in the top-dead-center (TDC) position (see FIG. 2)).

With the coolant conduit 30 positioned higher on the cylinder 14, the cylinder mid-stop 18 can also be located higher on the cylinder. Generally, the coolant conduit 30 should not radially overlap the cylinder mid-stop 18 and liner seat 28 interface. Accordingly, the axial position of the interface is limited by the axial position of the coolant conduit 30. Positioning the coolant conduit 30 higher creates space higher on the cylinder 14 within which the cylinder mid-stop 18 and liner seat 28 interface may be positioned. Some cylinder configurations have longer coolant conduits such that the interface between the mid-stop and liner seat is positioned lower on the cylinder. In the illustrated embodiment, the interface (and e.g., a lowermost point of the coolant conduit (e.g., the entirety of the coolant conduit) is positioned no more than a distance D₂ away from the top 19 of the combustion cavity 16. The distance D₁ is less than the distance D₂. In some embodiments, the distance D₂ is less than about 60% of the overall length of the piston 20. In yet some implementations, the distance D₂ is less than about 40% of the overall length of the piston 20.

As shown in FIG. 2, because the cylinder mid-stop 18 and liner seat 28 interface is positioned higher on the cylinder 14, when the piston 20 is in the topmost position (e.g., TDC), the skirt portion 23 of the piston is positioned below the interface. In other words, the mid-stop and liner seat interface does not radially overlap any portion of the skirt portion 23 of the piston 20 with the piston in its highest position. Accordingly, the cylinder mid-stop 18 and liner seat 28 interface never radially overlaps the skirt portion 23 during a full oscillatory cycle of the piston 20 within the combustion cavity 16. Therefore, the portion of the piston 20 most susceptible to wear and fatigue (i.e., the skirt portion 23) does not come into contact with the portion of the cylinder most susceptible to inflicting wear and fatigue onto the piston due to distortion (i.e., the cylinder mid-stop 18 and liner seat 28 interface). Generally, in some embodiments, the distance D₂ is less than the height H₂ of the head portion 21 of the piston 20.

Because the cylinder mid-stop 18 and liner seat 28 interface never radially overlaps the skirt portion 23, a peak thrust zone 40 defined on the interior surface 27 of the liner 26 is positioned below the coolant conduit 30 (see, e.g., FIG. 3). The maximum side thrust of the skirt portion 23 into the interior surface 27 of the liner 26 occurs within the peak thrust zone 40. As discussed above, the peak thrust zone for conventional cylinder configurations is located adjacent a coolant jacket, which introduces a strong propensity for cavitation within the coolant jacket. In the present cylinder configuration, because the peak thrust zone 40 is located well below the lower boundary line 54 of the coolant conduit 30, cavitation with the coolant conduit is prevented. Further, because the peak thrust zone 40 is located below the mid-stop and liner seat interface boundary line 52, significant wear on the piston 20 due to cylinder distortion within the peak thrust zone is eliminated. Additionally, in some implementations, the peak thrust zone 40 is located below the sealing member boundary line 50. Accordingly, performance degradation of the sealing member 36 due to peak thrust loads imparted on the sealing member is avoided.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An internal combustion engine, comprising:
a cylinder comprising a mid-stop shelf;
a liner positioned within the cylinder, the liner comprising a seat supported on the mid-stop shelf, wherein the liner defines a piston channel;
a coolant conduit between the cylinder and the liner, the coolant conduit being located above the mid-stop shelf and seat; and
a piston comprising a head portion and a skirt portion, the piston being movable within the piston channel between an uppermost position and a lowermost position, wherein in the uppermost position, the skirt portion is positioned below the mid-stop shelf and seat.

2. The internal combustion engine of claim 1, wherein the piston imparts a peak side thrust on the liner within a peak thrust zone, and wherein the peak thrust zone is located below the mid-stop shelf and the seat.

3. The internal combustion engine of claim 1, wherein an entirety of the coolant conduit is positioned above the mid-stop shelf and seat.

4. The internal combustion engine of claim 3, wherein the coolant conduit comprises an annular space extending circumferentially about the cylinder.

5. The internal combustion engine of claim 1, wherein the coolant conduit is defined at least partially by a channel formed in the liner.

6. The internal combustion engine of claim 1, further comprising an engine block, the engine block defining the cylinder, and wherein the coolant conduit is defined at least partially by a channel formed in the engine block.

7. The internal combustion engine of claim 6, wherein the coolant conduit is defined at least partially by a channel formed in the liner, and wherein the coolant conduit is defined between the channel formed in the engine block and the channel formed in the liner.

8. The internal combustion engine of claim 1, wherein an entirety of the coolant conduit is positioned a distance away from a top of the cylinder, and wherein the distance is less than about 60% of an overall length of the piston.

9. The internal combustion engine of claim 8, wherein the distance is less than about 40% of the overall length of the piston.

10. The internal combustion engine of claim 1, wherein an entirety of the coolant conduit is positioned a distance away from a top of the cylinder, and wherein the distance is less than a height of a head portion of the piston.

11. The internal combustion engine of claim 1, wherein a circumference of the head portion has a diameter that is less than a diameter of a circumference of the skirt portion.

12. The internal combustion engine of claim 1, wherein a height of the skirt portion is between about 40% and about 60% of an overall height of the piston.

13. A combustion cylinder assembly for an internal combustion engine having a piston that oscillates within the combustion cylinder assembly and imparts a peak side thrust within a peak thrust zone, the assembly comprising:
a cylinder comprising a mid-stop;
a liner positioned within the cylinder, the liner comprising a seat supported on the mid-stop; and
a coolant conduit between the cylinder and the liner, the coolant conduit being located above mid-stop and seat;
wherein the peak thrust zone is located below the mid-stop and seat.

14. The combustion cylinder assembly of claim 13, wherein the piston comprises a head portion and a skirt portion, the piston oscillating within the combustion cylinder assembly between uppermost and lowermost positions, wherein the assembly is configured such that when the piston is in the uppermost position, the skirt portion is positioned below the mid-stop and seat.

15. The combustion cylinder assembly of claim 13, wherein the coolant conduit is defined at least partially by a channel formed in the liner.

16. The combustion cylinder assembly of claim 15, wherein the channel formed in the liner aligns with a channel formed in an engine block of the internal combustion engine when the seat of the liner is supported on the mid-stop of the cylinder.

17. The combustion cylinder assembly of claim 13, wherein an entirety of the coolant conduit is positioned a distance away from a top of the cylinder, and wherein the distance is less than about 40% of an overall length of the piston.

18. The combustion cylinder assembly of claim 13, wherein an entirety of the coolant conduit is positioned a distance away from a top of the cylinder, and wherein the distance is less than a height of a head portion of the piston.

19. The combustion cylinder assembly of claim 13, wherein an entirety of the coolant conduit is positioned a distance away from a top of the cylinder, and wherein the distance is less than about 60% of an overall length of the piston.

20. An internal combustion engine, comprising:
a cylinder comprising a mid-stop shelf, the mid-stop shelf being positioned a distance away from a top of the cylinder;
a liner positioned within the cylinder, the liner comprising a seat supported on the mid-stop shelf, wherein the liner defines a piston channel;
a coolant conduit between the cylinder and the liner, the coolant conduit being located between the top of the cylinder and the mid-stop and seat; and
a piston movable within the piston channel, the piston having an overall length;
wherein the distance is less than about 60% of the overall length of the piston.
